(19) United States
(12) Patent Application Publication
(10) Pub. No.: US 2011/0173602 A1
(43) Pub. Date: Jul. 14, 2011

(54) EXECUTION ENVIRONMENT SOFTWARE, CLIENT DEVICE, AND SERVER DEVICE

(75) Inventors: Takao Togami, Kanagawa (JP); Jumpei Yamamoto, Tokyo (JP); Kazuo Yoshida, Chiba (JP)

(73) Assignee: ACCESS CO., LTD

(21) Appl. No.: 13/056,309

(22) PCT Filed: Jul. 17, 2009
(86) PCT No.: PCT/JP2009/062953

§ 371 Date: Mar. 21, 2011

(30) Foreign Application Priority Data
Jul. 30, 2008 (JP) 2008-195671

(51) Int. Cl. G06F 9/445; G06F 9/48; G06F 9/44

(52) U.S. Cl. 717/173; 718/102; 717/178

(57) ABSTRACT

An execution environment software application allows a computer to function as an identification information storage means for storing identification information about applications, identification information searching means for searching the identification information storage means for the identification information specified by a first application being executed, and an application execution instructing means for delivering predetermined delivery information created depending on the result of the execution of the first application of when the identification information is specified to a second application corresponding to the identification information and giving an instruction to execute the second application using the delivery information.

### TECHNICAL FIELD

The present invention relates to execution environment software for providing an application execution environment for coordination of a plurality of separate applications to work together, specifically to execution environment software adapted for coordination of Widgets which are simplified applications. The present invention also relates to a client device on which such execution environment software is installed, and a server connected to the client device via a certain network.

### BACKGROUND OF THE INVENTION

A simplified application, a so-called Widget which executes a particular function on a virtual desktop of a terminal device, has been known and in practical use. In general, a Widget is an application which is resident on a desktop, and executes a particular function, such as schedule management.

Recently, with development of Web technology, Widgets of the type enabling use of Web services on a desktop environment are now becoming widespread. Such a Widget supports standard Web technology, including HTML (Hyper Text Markup Language), XHTML (Extensible Hyper Text Markup Language), CSS (Cascading Style Sheets), JavaScript® and Ajax (Asynchronous JaveScript+XML), and provides a particular Web content, such as weather forecast, map and stock information (as disclosed, for example, in U.S. published patent application No. 2008/0082930). Since the functions of a Widget are limited, it is possible to provide contents for users in a low amount of consumption of resources. A Widget can be made by simply adding a function to a framework prepared for making of a Widget. That is, the Widget has an advantage that even if a user does not have specialized knowledge about making of an application, the user is able to make an application relatively easily.

Incidentally, when a user executes restaurant searching by using a Widget providing information concerning restaurants, the user may also check various types of information concerning the restaurant, such as map information around the restaurant, information on changing of trains and weather information around the restaurant. In this case, the user invokes other Widgets for providing related information, inputs, for example, an address of the restaurant into a form on each Widget, and checks the related information such as map information. However, it is a troublesome operation for the user to invoke each Widget and input data into a form on each Widget. In addition, the above described configuration is disadvantageous in that the user is not able to quickly browse the various types of information regarding the restaurant.

For this reason, one might consider to integrate various types of Widgets for providing the information concerning the restaurant and the related information into a single Widget which is able to provide integrated information. By integrating the various Widgets, it becomes possible to eliminate the need for requesting a user to invoke a plurality of Widgets. Furthermore, it becomes also possible to provide search results of the restaurant together with the related information (e.g., the map) for the user.

### DISCLOSURE OF THE INVENTION

However, there is a problem that since the above described Widget capable of providing the integrated information has a complicated configuration, it is difficult for the user, who does not have the specialized knowledge, to make such a complicated Widget. Therefore, the scheme to make a Widget integrating various types of Widgets is hard to employ.

In consideration of the above described circumstances, the object of the present invention is to provide execution environment software, a client device on which such execution environment software is installed, and a server connected to the client device via a certain network, which are configured to provide an application execution environment adapted to reduce an operation load on a user while executing separate applications.

In order to solve the above described problem, according to an embodiment of the invention, there is provided execution environment software providing an application execution environment for coordination of a plurality of individual applications, the execution environment software causing a computer to function as: an identification information storing means which stores identification information of the plurality of individual applications; an identification information searching means which searches the identification information storing means for the identification information of a second application when the identification information of the second application is designated on a first application being executed; and an application execution instruction means which passes delivery information which is generated based on an execution result of the first application when the identification information is designated, to the second application corresponding to the searched identification information, and instructs execution of the second application using the delivery information.

In view of the case where an application to be coordinated is not stored locally, the Execution environment software may cause the computer to function as: an application obtaining means which accesses a predetermined URI (Uniform Resource Identifier) and downloads the second application corresponding to the identification information when the identification is not found by a searching process by the identification information searching means; and an application installation means which installs the downloaded second application in the computer, and causes the identification information storing means to store the identification information of the second application.

The Execution environment software may further cause the computer to function as: a confirmation message presenting means which, before downloading the second application, presents a confirmation message to inquire a user whether to execute the downloading. In this case, the application obtaining means downloads the second application only when the downloading is permitted through the confirmation message.

The Execution environment software may further causes the computer to function as: an update judging means which judges whether it is necessary to update an application based on a version of the application installed in the computer; and an application updating means which downloads update data of the application and updates the application when it is judged by the update judging means that the update of the application is necessary.

The plurality of individual applications for which the execution environment software provides the execution environment may be Widgets which are simplified applications.

A client device according to an embodiment of the invention for solving the above described problem is a device on which any of the above described execution environment software is installed.

A server device according to an embodiment of the invention for solving the above described problem is connected to the above described client device via a network, and manages the plurality of individual applications by associating the plurality of applications with respective pieces of identification information.

As described above, according to the execution environment software, the client device and the server device of the present invention, it is possible to reduce the load placed on a user by coordination of the individual applications on an as needed basis.

### BRIEF DESCRIPTION OF THE DRAWINGS

FIG. 1 illustrates a network configuration for explaining an embodiment of the invention.

FIG. 2 illustrates an outer appearance of a mobile phone according to the embodiment of the invention.

FIG. 3 is a block diagram illustrating a general configuration of the mobile phone according to the embodiment of the invention.

FIG. 4 is a functional block diagram of a browser engine included in a browser according to the embodiment of the invention.

FIG. 5 is a conceptual diagram illustrating a Widget execution environment for executing various Widgets installed in the mobile phone according to the embodiment of the invention.

FIG. 6 is a representation example of Widgets on a display according to the embodiment of the invention.

FIG. 7 is a flowchart illustrating a Widget coordination process executed by a Widget manager according to the embodiment of the invention.

FIG. 8 is a representation example of Widgets on the display according to the embodiment of the invention.

FIG. 9 is a representation example of Widgets on the display according to the embodiment of the invention.

FIG. 10 is a representation example of Widgets on the display according to the embodiment of the invention.

FIG. 11 is a flowchart illustrating a Widget coordination process executed by a Widget manager according to an embodiment of the invention.

### BEST MODE FOR CARRYING OUT THE INVENTION

Hereafter, an embodiment according to the invention is described with reference to the accompanying drawings.

First, terms used herein are defined as follows.

Network: Various types of networks including a mobile communication network of a mobile communication carrier, an intranet and the Internet.

Contents: a group of information including video, an image, sound, a document, data such as a work sheet or a combination thereof to be browsed by a user. Contents are transmitted through a network or is stored in a terminal device.

Web contents: a form of contents. The Web contents are a group of information transmitted through a network.

Web page: a form of Web contents. The Web page represents an entire content to be displayed when a user designates an URL. That is, the Web page represents an entire content which can be displayed by scrolling onscreen representation on a display. The Web page includes not only a Web page being browsed online but also a Web page being browsed offline. The Web page being browsed offline includes, for example, a page which is cached by a browser after having been received from the Internet, or a page stored, for example, in a local folder of a terminal device in an mht format. The Web page includes various types of information (Web page data), such as, an HTML document, an XHTML document, an image file, sound data and etc.

According to the above described definitions, contents include Web contents, and Web contents include a Web page.

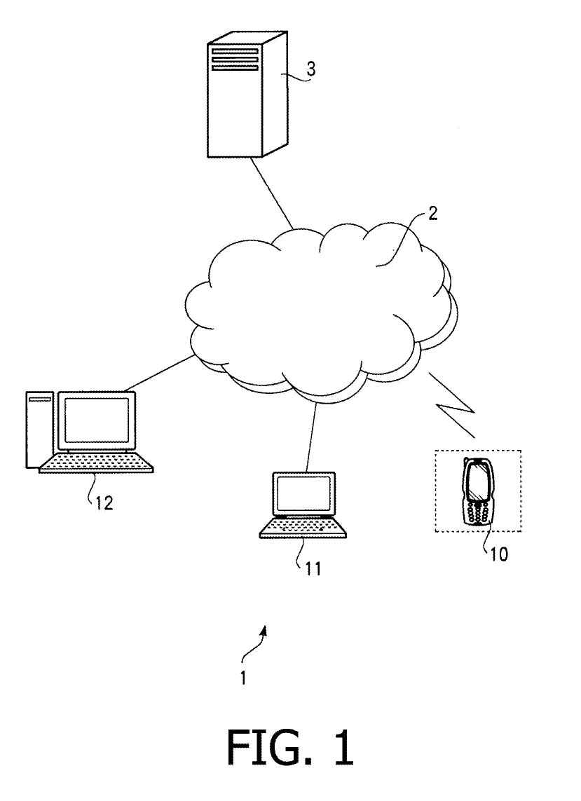

FIG. 1 illustrates a network configuration for explaining the embodiment of the invention. As shown in FIG. 1, in a network system 1 according to the embodiment, a Web server 3 and client terminals (a mobile phone 10, a note PC (Personal Computer) 11 and a desktop PC 12) are connected via a network 2 including a carrier network. The client device may be replaced with another type of terminal device on which a Web browser is installed, such as, a PDA (Personal digital Assistants), a PHS (Personal Handy phone System), a portable game device and a home appliance.

Each client device exchanges data with the Web server 3 or other Web servers (now shown) through the network 2, and provides various types of Web services for users. In the following, the mobile phone 10 is explained in detail as a client device which communicates with Web servers.

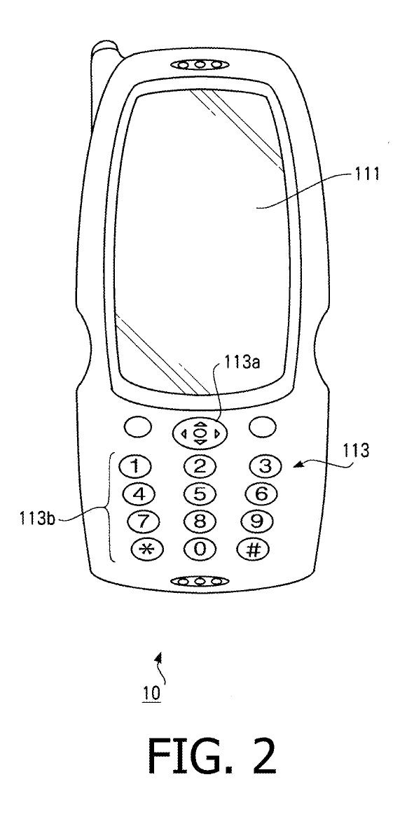

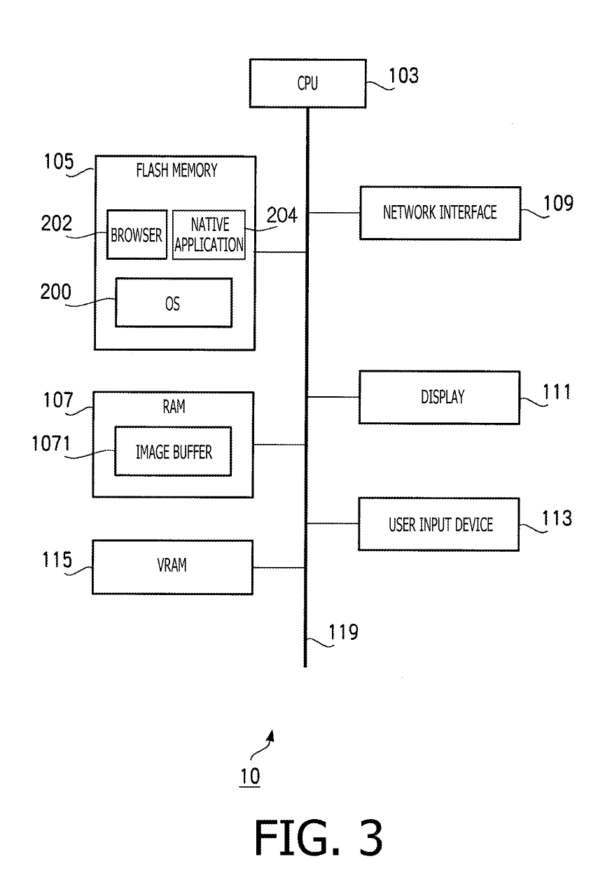

FIG. 2 illustrates an outer appearance of the mobile phone 10. FIG. 3 is a block diagram generally illustrating a configuration of the mobile phone 10. As shown in FIG. 3, the mobile phone 10 includes a CPU (Central Processing Unit) 103 which totally controls the entire client device. Each component configuring the mobile phone 10 is connected to the CPU 103 via a system bus 119. As components configuring the mobile phone 10, the mobile phone 10 includes a flash memory 105, a RAM (Random Access Memory) 107, a network interface 109, a display 111, a user input device 113 and a VRAM (Video Access Memory) 115. The system bus 119 includes a power line in addition to a data line. To the components including the CPU 103, power is supplied via the power line from a battery which is not shown in the drawings.

After the mobile phone 10 is turned ON, the CPU 103 accesses necessary hardware components via the system bus 119. For example, immediately after the mobile phone 10 is turned ON, the CPU 103 accesses the flash memory 105 to read an OS (Operating System) 200, and loads the OS 200 onto the RAM 107 to invoke the OS 200. Then, the components execute various types of processing by coordinating with each other as appropriate under control of the OS 200 managing resources and processes.

For example, when an operation for invoking a browser 202 is conducted through the user input device 113, the OS 200 loads the browser 202 onto the RAM 107 to execute the browser 202 on the OS 200. The browser 202 invoked by the OS 200 executes a process in coordination with hardware, such as the CPU 103, in response to, for example, a user operation for accessing Web contents. As a result of such a process, the user is able to execute Web browsing through the display 111, i.e., to browse Web contents. It should be noted that in the flash memory 105, a native application 204 is stored as an application other than the browser 202. Although in the drawing only one native application 204 is illustrated for the sake of simplicity, practically a plurality of native applications exist. As an example of a native application, an application, such as an address book application and a mailer which are usually installed on a typical mobile phone, can be cited.

As the user input device 113, the mobile phone 10 is provided with a five-way key 113a and a ten-key 113b. The five-way key 113a is an integrated key including four (up, down, left and right) direction keys and an enter key. When a user operation for operating the user input device 113 is conducted, an input signal corresponding to the user operation is inputted to the CPU 103. Then, the CPU 103 executes a process corresponding to the user operation so that various functions including the Web browsing can be performed on the mobile phone 10. During the Web browsing, a user is able to scroll the Web contents being browsed, by operating any of the five-way key 113a and the ten-key 113b. Furthermore, the user is able to select a form or a link on the contents by operating the five-way key 113a or the ten-key 113b.

It should be noted that the user input device 113 is not limited to a mechanical key, such as the 5-way key 113a and the ten-key 113b. The user input device 113 may be configured by another type of key input device, such as a membrane key or a touch panel.

If the user input device 113 is configured with a touch panel, an operation screen corresponding to operation keys is configured by a display screen which is integrated with the display 111 or is provided separately from the display 111. In the former case, the display 111 itself is configured with a touch panel. In the latter case, the terminal device 10 includes two screens, i.e., the display 111 and an operation touch panel. Furthermore, in the latter case, whether to configure the display 111 with a touch panel is determined in accordance with design specifications.

As described above, if the user input device 113 is configured with a touch panel, a GUI (Graphical User Interface) environment in which an operation such as scrolling is conducted by pen-touch or finger-touch on an operation key displayed on the screen is provided. It is also possible to provide a GUI environment where various operations are conducted, for example, by directly touching a screen on which Web contents are displayed. Under such a GUI environment, when the user moves the user's finger on a touch panel surface in the upward, downward, left or right direction from a state where the user's finger touches the touch panel surface at a certain point on the Web contents, scrolling is executed accordingly (e.g., by moving upward the user's finger on the touch panel surface, the Web contents are scrolled downward). That is, in this case, since scrolling is executed in response to movement of a stylus or a finger, more intuitive operability can be provided for the user.

The user input device 113 may be configured by appropriately combining various types of keys, such as a mechanical key, a membrane key and a touch panel. Furthermore, the user input device 113 may be an operation terminal (e.g., a remote controller) provided separately from the terminal device 10.

Furthermore, a component other than a mechanical key, a membrane key and a touch panel may be installed in the user input device 113. As examples of such a component, a gyro-sensor, an acceleration sensor and a jerk sensor are named. In this case, the CPU 103 measures, for example, a tilting angle, an angular velocity, an acceleration and a jerk (a time-rate-of-change of an acceleration), so that scrolling responsive to measured values can be achieved by coordination between the CPU 103 and the browser 202. For example, when the user moves or tilts the terminal device 10 in the upward, downward, left or right direction, scrolling responsive to the moving direction, moving speed or the tilting angle, etc. is executed. Such a configuration enables the user to intuitively scroll a display area of the Web contents.

The terminal device 10 according to the embodiment is designed to have a screen aspect ratio of 3:4 (i.e., portrait representation) in a normal use state (i.e., in a state where the terminal device 10 is oriented such that the up-and-down direction in FIG. 1 coincides with the vertical direction). When the posture of the terminal device 10 is changed from the above described state, the CPU 103 detects change of the posture of the terminal device 10 based on outputs from the sensors such as a gyro sensor. For the Web contents being displayed on the display 111, the browser 202 executes rendering responsive to the posture of the terminal device 10 based on detection results by the CPU 103. For example, when the terminal device 10 is rotated by 90 degrees from the posture shown in FIG. 2, the screen aspect ratio changes to 4:3 (i.e., landscape representation). At this time, the browser 202 executes again rendering for the Web contents being displayed on the display 111 in accordance with the landscape screen. As described above, if the orientation of the screen is changed, line-wrapping positions of text by the rendering are also changed, and, as a result, appearance of the Web page changes.

As shown in FIG. 2, the terminal device 10 according to the embodiment is configured as a so-called straight type mobile phone which holds the display 111 and the user input device 113 with an integrated body. However, the terminal device 10 may employ another body type. In another embodiment, a folding type, a rotational biaxial hinge type, a cycloid type or a swing type structure may be employed. For example, a mobile phone of a cycloid type or a swing type is configured such that a display side body holding the display 111 is rotatable, in a plane parallel with the display 111, relative to a main body holding the user input device 113. In such a mobile phone, the orientation of the screen changes in response to the rotational angle of the display side body. The browser 202 executes again rendering for the Web contents being displayed on the display 111 so as to work in conjunction with the changed orientation of the screen.

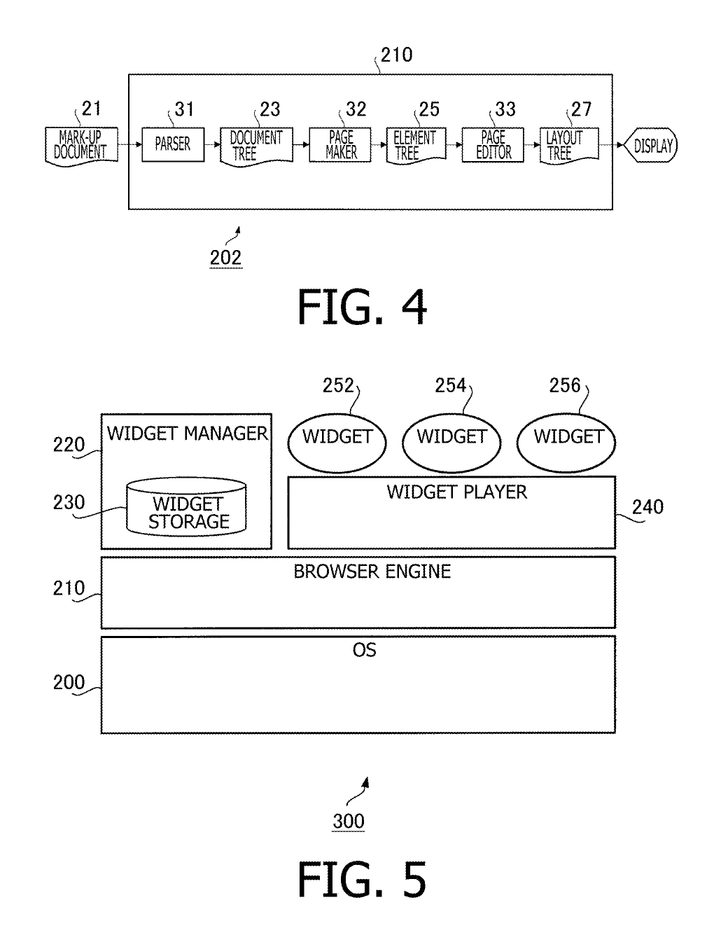

Next, functions of the browser 202, particularly a browser engine 210 which is a primary component of the browser 202, are explained in detail. FIG. 4 illustrates a functional block diagram of the browser engine 210. As shown in FIG. 4, the browser engine 210 includes various functional blocks including a parser 31, a page maker 32 and a page editor 33.

When an accessing operation to Web contents, e.g. input of a URI through the user input device 113 (or a URI is designated by selection of an anchor element on the Web contents, or a URI stored as a bookmark or history in the terminal device 10 is selected), is conducted, the browser 202 generates a request message requesting for resources such as Web contents in compliance with HTTP (Hypertext Transfer Protocol), and transmits the request message to a designated URI.

Then, a server corresponding to the designated URI generates a response message corresponding to the received request message and replies. The replied response message reaches to the browser 202 through the network and the response message is passed to the parser 31. In a message body of the response message, a markup document 21 designated by the URI, which is described in HTML or XHTML, etc., is embedded.

The parser 31 analyzes the markup document 21, generates a document tree 23 (for example, a DOM (Document Object model) tree) which represents a logical structure of the markup document 21 in a tree structure, and loads the document tree into the RAM 107. The document tree 23 is data which has nodes corresponding to respective elements of the markup document 21 and which represents an outline of the markup document 21. The document tree 23 only describes the logical structure of the markup document 21, and does not include information about representation of the document.

The page maker 32 generates an element tree 25 including information of a display style, such as block, inline, table, and list, etc. defined by each tag, based on the document tree 23, and executes a registration of a request of an image and an event process designated in the markup document 21 to be stored in the RAM 107. The element tree 25 represents an order in which block, inline, and table, etc., exist. However, the element tree 25 does not include information about which position and with what widths and heights these elements (block, inline, table, etc.) are displayed, and information about from where the text is wrapped, etc.

A page editor 33 determines one-by-one the layout (i.e., wrapping of text, and the position, width and height of each element on the screen) and a color of each node (element) of the element tree 25, and generates a layout tree 27 representing a layout of each element.

Each element for which the layout has been determined is successively rendered in a certain area on the RAM 107 by the page editor 33. Of results of the rendering in the certain area, a rendering result which is to be displayed on the display 111 is written into the VRAM 115.

The VRAM 115 is a memory for storing data which is directly displayed on the display 111, and has an image area corresponding to the screen size of the display 111. In the VRAM 115, the data rendered in the above described certain area is written together with an image, such as a tool bar. Through the above described processing by the browser 202, the Web contents are displayed on the display 111.

Incidentally, when a user browses the Web contents, the user usually uses the browser 202 on which a number of functions are implemented so that the user is able to receive various types of Web services. On the other hand, when the user wants to browse merely a particular content, such as weather forecast, map information or router searching, the user uses a Widget on which a browsing function for a particular content is implemented. It should be noted that although in general a Widget is resident on a virtual desktop of the mobile phone 10 after startup of the OS 200, the mobile phone 10 may be set such that a Widget is invoked on an as needed basis.

FIG. 5 is a conceptual diagram illustrating a Widget execution environment 300 for executing various Widgets installed on the mobile phone 10. In an upper layer of the browser engine 210, a Widget manager 220 and a Widget player 240 which operate on the basis of the browser engine 210 are implemented. The Widget manager 220 and the Widget player 240 can be obtained from, for example, the Web server 3 on which a community site for distributing Widgets has been included.

On the community site of the Web server 3, a Widget package storing a file group configuring Widgets for providing weather forecast, map information and route searching is arranged. Specifically, the Widget package is data in which an XML (Extensible Markup Language) manifest and Web contents (e.g., HTML+CSS) are packaged in a zip format. The Widget package is standardized, for example, in Widgets 1,0 Requirements (http://www.w3.org/TR/2007/WD-widgets-reqs-20070209/) of W3C. The XML manifest is a file for defining required information of Widgets, and has information such as a name of a Widget and a creator of a Widget.

The Web server 3 has a predetermined management table for Widgets, and manages Widgets by associating a Widget ID with each Widget package (i.e., each Widget). The Widget ID is a unique ID for identifying each Widget on a computer.

When the Widget package on the Web server 3 is selected, for example, through a user operation, the Widget manager 220 obtains the selected Widget package and information (hereafter, referred to as “Widget information”) concerning the Widget. The Widget information includes, for example, a Widget name, a Widget ID, a Widget version, a package URL and a package size. The Widget ID included in the Widget information is identical with an ID which the Web server 3 uses to manage Widget packages. Old and new Widgets whose versions are different are assigned the same Widget ID, and are assigned different Widget versions.

The Widget manager 220 compares the Widget information (Widget ID) obtained from the Web server 3 with the Widget information (Widget ID) of each Widget which has already been installed in the Widget storage 230, and judges whether the Widget package selected on the Web server 3 has already been installed. When no Widget ID identical with the Widget ID obtained from the Web server 3 is found, the Widget manager 220 downloads the Widget package and installs the downloaded Widget package in the Widget storage 230. Through such an installation process, the Widget can be stored in the Widget storage 230 while being associated with the Widget information and the XML manifest.

On the other hand, when the Widget ID identical with the Widget ID obtained from the Web server 3 is found in the Widget storage 230, the Widget manager 220 makes a comparison between Widget versions to judge whether the Widget package on the Web server 3 has a newer version. Only when the Widget package on the Web server 3 is a newer version, the Widget manager 220 downloads and installs the Widget package to update the Widget. When the Widgets versions are identical with each other or the Widget package on the Web server 3 is an older version, the Widget manager 220 displays, on the display 111, a message indicating that the latest Widget package has already been installed, and does not execute a downloading process.

The timing of updating of a Widget is not limited to the timing of selecting a Widget package on the Web server 3. The process for updating a Widget may be executed periodically by the Widget manager 220 for each Widget installed on the Widget storage 230.

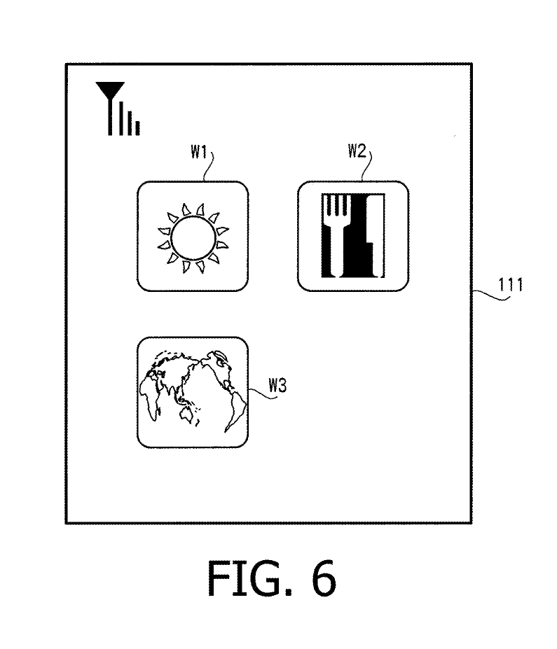

Under management by the Widget manager 220, the Widget player 240 loads the designated Widget in the Widget storage 230 immediately after invocation of the OS 200 or at the time of a user operation. Specifically, the Widget player 240 executes, through a progress process, an analyzing process, a rendering process and a JavaScript® executing process for the Widget content (i.e., the Web content packaged in the Widget package) by the browser engine 210, and creates a small window which is smaller than the screen size of the display 111, for each Widget content. Next, the data drawn by the browser engine 210 is displayed on each window made for each Widget content. As a result, as shown for example in FIG. 6, a weather forecast Widget W1, a restaurant search Widget W2 and a map search Widget W3 are invoked and displayed on the virtual desktop of the display 111. It should be noted that the Widget player 240 also executes control concerning displaying of windows, such as a maximization display process and a minimization display process for a Widget content, a process for changing a display position of a Widget content, and overlapping of Widget contents.

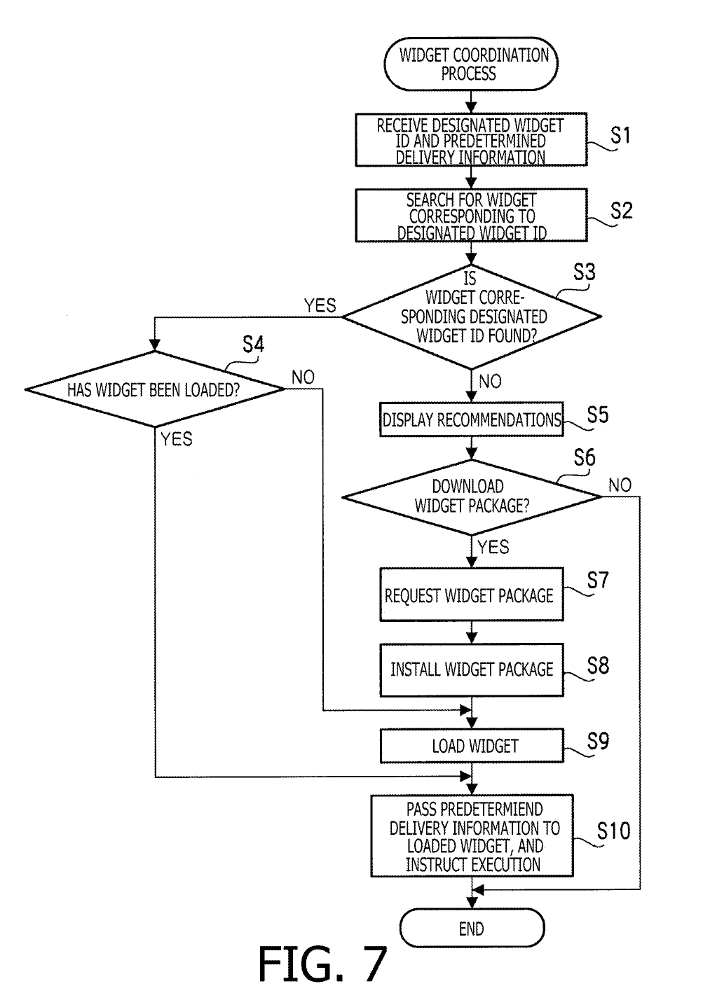

Conventionally, in order to check a map around a searched restaurant and to download a coupon of the restaurant after the user conducting searching of the restaurant using the restaurant search Widget, the user is required to invoke another Widget such as a map search Widget and a coupon search Widget, and to input an address, a name and etc. of the restaurant into a form of each Widget. However, to invoke each Widget and input data into a form of each Widget is troublesome for the user. In addition, there were disadvantages that various types of information concerning the restaurant cannot be browsed quickly. For this reason, in this embodiment, the Widget manager 220 is configured to execute a Widget coordination process shown as a flowchart in FIG. 7. In the flowchart of FIG. 7 and in the following, each step is abbreviated by “S”.

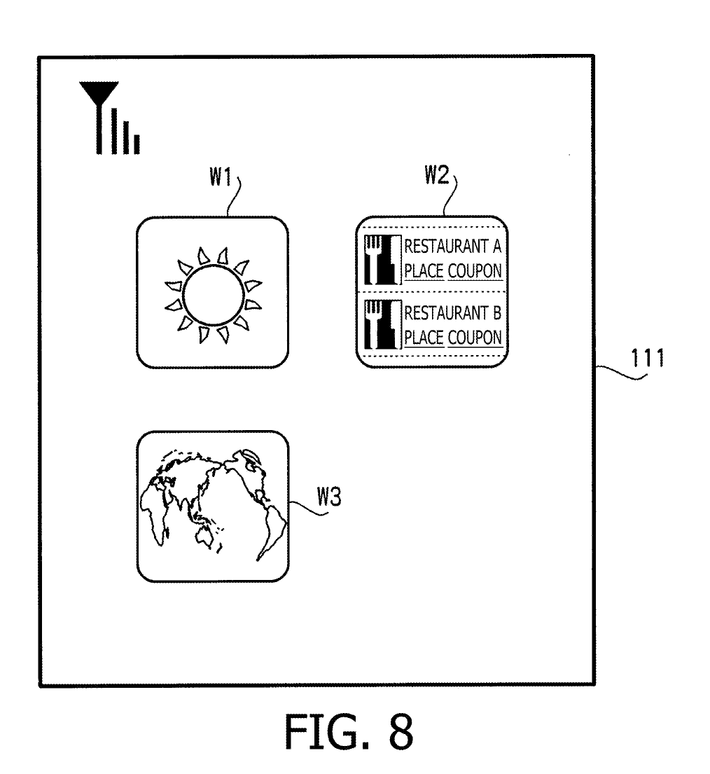

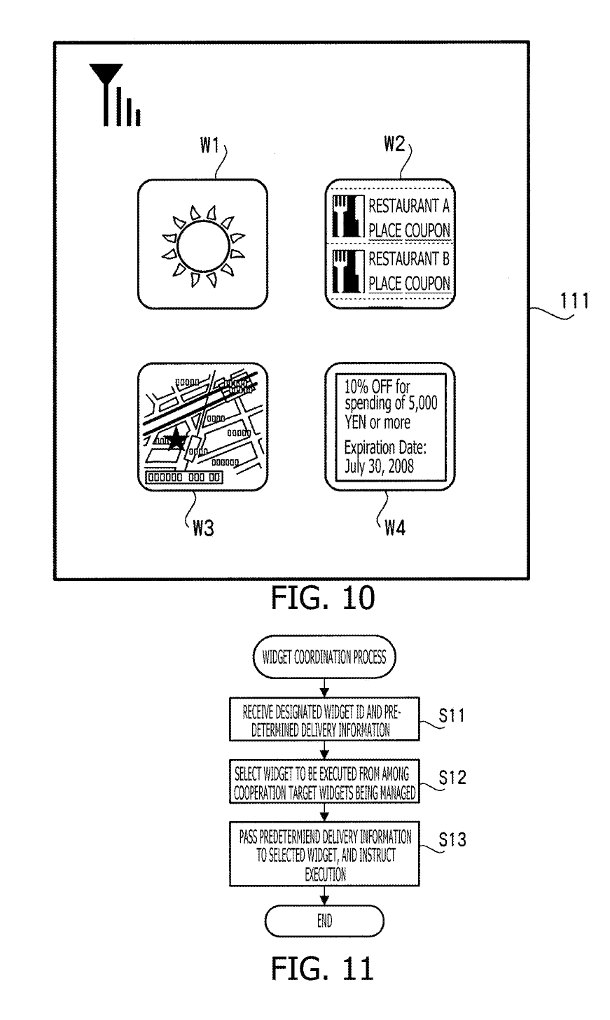

For example, when search of a restaurant is executed by the restaurant search Widget W2, search results matching a search condition are displayed on the restaurant search Widget W2 as shown in FIG. 8. It should be noted that in each of FIGS. 8 to 10, all the underlined text on the search results of the restaurant search Widget W2 is link text. Each link text designates a Widget to be invoked, and is described to pass predetermined delivery information to the designated Widget. Specifically, the link text “place” is assigned a Widget ID of the map search Widget W3 to invoke the map search Widget W3. Furthermore, the link text “place” is described to pass the address information of the searched restaurant to the invoked map search Widget W3. Furthermore, link text “coupon” is assigned a Widget ID of a coupon search Widget W4 to invoke the coupon search Widget W4 (see the following FIG. 10).

For example, when the link text “place” of the restaurant A is clicked, the designated Widget ID, i.e., the Widget ID of the map search Widget W3, and the address information of the restaurant A are passed from the restaurant search Widget W2 to the Widget manager 220 (S1). The widget manager 220 searches the Widget storage 230 for a corresponding widget, i.e., the map search Widget W3, by using the received Widget ID as a search key (S2).

In this embodiment, the map search Widget W3 has been installed in the Widget storage 230. Therefore, after searching the Widget storage 230 for the map search Widget W3 (S3: YES), the process proceeds to S4 where the Widget manager 220 judges whether the map search Widget W3 has been loaded by the Widget player 240.

In this embodiment, the map search Widget W3 has been already loaded by the Widget player 240 (S4: YES). Therefore, the process proceeds to S10. On the other hand, when the map search Widget W3 has not been loaded (S4: NO), the Widget manager 220 controls the Widget player 240 to load the map search Widget W3 (S9), and the process proceeds to S10.

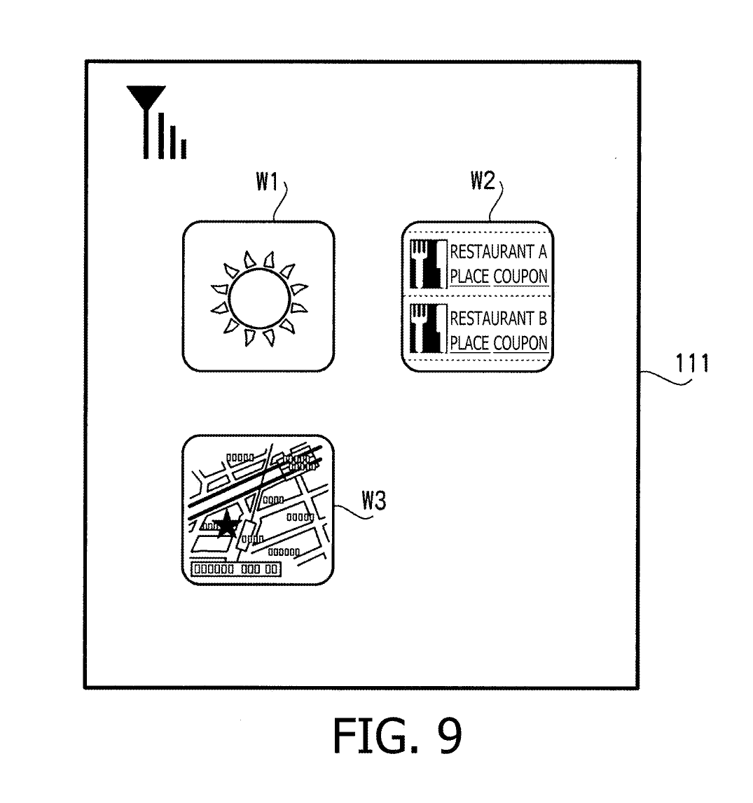

In the process of S10, the Widget manager 220 passes the address information of the restaurant A received in the process of S1 to the loaded map search Widget W3, and instructs the map search Widget W3 to execute the map searching by using the address information as a search key (S10), and the Widget coordination process terminates. The map search Widget W3 operates on the Widget player 240 based on instructions from the Widget manager 220, creates a message for requesting the surrounding map of the restaurant A and accesses a predetermined map site, and downloads the surrounding map data. Next, using the downloaded surrounding map data, the analyzing process, the rendering process and the Javascript® executing process by the browser engine 210 are executed, and a map image obtained as an execution result is displayed on a window. Through such processes, as shown in FIG. 9, the result of the map searching which indicates the location of the restaurant A is displayed on the map searching Widget W3.

For example, when the link text “coupon” of the restaurant A is clicked, the designated Widget ID, i.e., the Widget ID of the coupon search Widget W4, and name information of the restaurant A are passed from the restaurant search Widget W2 to the Widget manager 220 (S1). The widget manager 200 searches the Widget storage 230 for a corresponding Widget, i.e., the coupon search Widget W4, by using the received Widget ID as a search key (S2).

In this embodiment, since the coupon search Widget W4 has not been installed in the Widget storage 230, the coupon search Widget W4 is not found in the Widget storage 230 (S3: NO). Therefore, the Widget manager 220 controls the process to proceed to S5 and to display recommendations on the display 111. The recommendations include a message “You can download a coupon of a shop by using a coupon search Widget. Do you install? “YES” “NO””.

When “NO” of the recommendations is clicked (S6: NO), the Widget manager 220 deletes the recommendations and terminates the Widget coordination process. On the other hand, when “YES” of the recommendations is clicked (S6: YES), the Widget manager 220 accesses the Web server 3, and requests for a Widget package corresponding to the Widget ID received in the process of S1, i.e., a Widget package of the coupon search Widget W4 (S7).

The Web server 3 searches the widget management table for the Widget package of the coupon search Widget W4 by using the Widget ID contained in a request message, and sends the searched Widget package to the Widget manager 220. The Widget manager 220 installs the Widget package which is downloaded as described above in the Widget storage 230 (S8). Then, the Widget manager 220 controls the Widget player 240 to load the installed coupon search Widget W4 (S9), and the process proceeds to S10.

In the process of S10, the Widget manager 220 passes the name information of the restaurant A received in the process of S1 to the loaded coupon search Widget W4, and instructs the coupon search Widget W4 to execute the coupon searching by using the name information as a search key (S10), and terminates the Widget coordination process. The coupon search Widget W4 operates on the Widget player 240 based on instructions from the Widget manager 220, creates a message requesting for coupon information of the restaurant and accesses a predetermined coupon site, and downloads the coupon data. Next, using the downloaded coupon data, the Widget W4 executes the analyzing process, the rendering process and the Javascript® executing process by the browser engine 210, and displays a coupon image obtained as an execution result on a window. Through such processes, the result of the coupon available on the restaurant A is displayed on the coupon search Widget W4.

As described above, by controlling Widgets each having a single function to coordinate with each other on an as needed basis by the Widget manager 220, it becomes possible to eliminate the need for a user operation for invoking a plurality of Widgets. Such a configuration also eliminates the need for conducting a form input to browse the related information for each of the Widgets. That is, according to the embodiment, the operation load placed on the user can be reduced, and the user is able to quickly browse the related information.

By displaying the recommendations on an as needed basis, it becomes possible to enable the user to successively install useful Widgets for coordination between Widgets without requiring the user to search for Widgets. By installing a Widget in accordance with the recommendations, the user is able to enhance the coordination function between the Widgets. Furthermore, since installation of the Widgets is recommended through the recommendations, a creator of a Widget is able to enjoy an advantage that the chances that the Widget made by the creator is used by the user increase.

Furthermore, the Widget manager 220 manages coordination information of currently loaded Widgets (e.g., the coordination information indicating which of Widgets serves as a coordination source and which of the Widgets operates in coordination with the coordination source). In the example shown in FIG. 10, the Widget manager 220 manages the restaurant search Widget W2 as a coordination source Widget, and manages the map search Widget W3 and the coupon search Widget W4 as coordination target Widgets. Therefore, the Widget manager 220 has already known that the map search Widget W3 and the coupon search Widget W4 which are the coordination target Widgets for the restaurant search Widget W2 have been loaded. Therefore, when the link text “place” of a restaurant B of the restaurant search Widget W2 is clicked, the Widget manager 220 executes a Widget coordination process shown as a flowchart in FIG. 11. That is, as in the case of S1 of FIG. 7, the Widget manager 220 receives the Widget ID of the map search Widget W3 and the address information of the restaurant B from the restaurant search Widget W2 (S11). Next, the Widget manager 220 selects the map search Widget W3 from among the coordination target Widgets which the Widget manager 220 manages (S12), and executes the process similar to S10 of FIG. 7, i.e., the Widget manager 220 passes the address information of the restaurant B received in the process of S11 to the map search Widget W3, and instructs the map search Widget W3 to execute the map searching by using the address information as a search key (S13). That is, after executing the process similar to S1 in FIG. 7, the Widget manager 220 executes the process of S12 in place of the processes of S2 to S9 of FIG. 7, and then executes the process similar to S10. As a result, the map search result is immediately changed from the map around the restaurant A to the map around the restaurant B.

On a community site of the Web server 3, various APIs (Application Programming Interfaces) required for realizing the coordination between the Widgets are opened. Therefore, a Widget creator is able to install the coordination function between Widgets on the Widget that the creator has made, by utilizing the opened APIs.

Although the present invention has been described in considerable detail with reference to certain preferred embodiments thereof, other embodiments are possible. For example, the information for identifying the Widget package or the Widget contents is not limited to a unique ID such as a Widget ID, but may be identification information defined as an upper level concept, such as classification or a category.

The Widget manager 220 is able to pass, to a particular native application, the information for the coordination by executing direct designation through API or the OS 200, as well as a Widget designated by a Widget ID. Let us consider a case where a telephone number or a mail address displayed on a Widget for SNS (Social Networking Site) is clicked. In this case, the Widget manager 220 displays recommendations for recommending invocating an native application, such as an address book application or a mailer, on the display 111. When the address book application is selected, a call to a friend's phone number is started. When the mailer is selected, the mailer is invoked, and the screen for creating a mail is displayed and a friend's mail address is inputted to an address field. That is, the Widget manager 220 is able to cause the Widget to cooperate with the native application 204 (and further with the non-native application).

1: A computer-readable medium having computer-readable instructions for execution environment software providing a Web application execution environment for coordination of a plurality of Web applications whose information can be updated via a network, the instruction configuring a processor of a computer to function as:
a Web application processing unit which has functions of analyzing at least a markup language and a script constituting the plurality of Web applications and executing the plurality of Web applications;
an identification information storing unit which stores identification information of the plurality of Web applications;
an identification information searching unit which searches the identification information storing unit for the identification information of a second Web application when the identification information of the second Web application is designated on a first Web application being executed; and
an application execution instruction unit which passes delivery information which has been generated based on an execution result of the first Web application when the identification information is designated, to the second Web application corresponding to the searched identification information, and instructs execution of the second Web application using the delivery information.

2: The computer-readable medium according to claim 1, the instructions further causing the processor to function as:
a Web application obtaining unit which accesses a predetermined URI (Uniform Resource Identifier) and downloads the second Web application corresponding to the identification information when the identification information is not found by a searching process by the identification information searching unit; and
a Web application installation unit which installs the downloaded second Web application in the computer, and causes the identification information storing unit to store the identification information of the second Web application.

3: The computer-readable medium according to claim 2, the instructions further causing the processor to function as:
a confirmation message presenting unit which, before downloading the second Web application, presents a confirmation message to inquire a user whether to execute the downloading,
wherein the Web application obtaining unit downloads the second Web application only when the downloading is permitted through the confirmation message.

4: The computer-readable medium according to claim 1, the instructions further causing the processor to function as:
an update judging unit which judges whether it is necessary to update a Web application based on a version of the Web application installed in the computer; and
a Web application updating unit which downloads update data of the Web application and updates the Web application when it is judged by the update judging unit that the update of the Web application is necessary.

5: The computer-readable medium according to claim 1, wherein the plurality of Web applications are Widgets.

6: A client device on which execution environment software providing a Web application execution environment for coordination of a plurality of Web applications, whose information can be updated via a network, is installed, the client device comprising:
a Web application processing unit which has functions of analyzing at least a markup language and a script constituting the plurality of Web applications and executing the plurality of Web applications;
an identification information storing unit which stores identification information of the plurality of Web applications;
an identification information searching unit which searches the identification information storing unit for the identification information of a second Web application when the identification information of the second Web application is designated on a first Web application being executed; and
an application execution instruction unit which passes delivery information which has been generated based on an execution result of the first Web application when the identification information is designated, to the second Web application corresponding to the searched identification information, and instructs execution of the second Web application using the delivery information.

7: A server device connected, via a network, to a client device on which execution environment software providing a Web application execution environment for coordination of a plurality of Web applications, whose information can be updated via a network, is installed, the client device comprising:
a Web application processing unit which has functions of analyzing at least a markup language and a script constituting the plurality of Web applications and executing the plurality of Web applications;
an identification information storing unit which stores identification information of the plurality of Web applications;
an identification information searching unit which searches the identification information storing unit for the identification information of a second Web application when the identification information of the second Web application is designated on a first Web application being executed; and
an application execution instruction unit which passes delivery information which has been generated based on an execution result of the first Web application when the identification information is designated, to the second Web application corresponding to the searched identification information, and instructs execution of the second Web application using the delivery information,
the server device managing the plurality of individual applications by associating the plurality of applications with respective pieces of identification information.

8: A method to be implemented on a computer for coordination of a plurality of Web applications, whose information can be updated via a network, on a Web application execution environment implemented by execution environment software, the method comprising:
executing one of the plurality of Web applications by analyzing at least a markup language and a script constituting the plurality of Web applications;
searching a storage unit storing identification information for the identification information of a second Web application when the identification information of the second Web application is designated on a first Web application being executed; and
passing delivery information which has been generated based on an execution result of the first Web application when the identification information is designated, to the second Web application corresponding to the searched identification information; and
instructing execution of the second Web application using the delivery information.

9: The method according to claim 8, further comprising:
accessing a predetermined URI (Uniform Resource Identifier) and downloading the second Web application corresponding to the identification information when the identification information is not found by the step of searching;
installing the downloaded second Web application in the computer; and
storing the identification information of the second Web application in the storage unit.

10: The method according to claim 9, further comprising:
before the second Web application is downloaded, presenting a confirmation message to inquire a user whether to execute the downloading,
wherein the second Web application is downloaded only when the downloading is permitted through the confirmation message.

11: The method according to claim 8, further comprising:
judging whether it is necessary to update a Web application based on a version of the Web application installed in the computer; and
downloading update data of the Web application and updating the Web application when it is judged that the update of the Web application is necessary.

12: The method according to claim 8, wherein the plurality of Web applications are Widgets.
